(19) United States
(12) Patent Application Publication
(10) Pub. No.: US 2018/0169645 A1
(43) Pub. Date: Jun. 21, 2018

(54) Method of Acid Manufacturing Using Acid cation resins for Recycling Salt and/or Salt Products from Wastes and/or Waste Waters

(71) Applicant: Gerald J. Grott, Phoenix, AZ (US)

(72) Inventor: Gerald J. Grott, Phoenix, AZ (US)

(21) Appl. No.: 15/890,253

(22) Filed: Feb. 6, 2018

Related U.S. Application Data
(60) Provisional application No. 62/430,507, filed on Dec. 6, 2016.

(51) Int. Cl. B01J 39/07; B01J 39/14; B01J 49/53; C02F 1/28; C02F 1/42; C01B 7/01; C01B 17/69

(52) U.S. Cl. CPC B01J 39/07; B01J 39/14; B01J 49/53; C02F 1/286; C02F 2101/12; C01B 7/01; C01B 17/69; C02F 2001/425; C02F 1/42

(57) ABSTRACT

A method of acid manufacturing using acid cation resins for recycling salt and/or salt products from wastes and/or waste waters utilizes a brine solution, an acid cation resin, an acid solution, and an ion exchanger. The acid cation resin is into hydrogen form with the acid solution within the ion exchanger. The acid cation resin is then washed using water with salinity to remove any excess acid from the exterior of the acid cation resin. A selected brine of salts is then prepared of the desired acid(s) to be produced. The desired acid is produced by contacting the acid cation resin containing cations in concentration with the selected brine. A second ion exchange reaction is executed to substitute hydrogen for cations in the selected brine.

The current application claims a priority to the U.S. Provisional Patent application Ser. No. 62/430,507 filed on Dec. 6, 2016.

### FIELD OF THE INVENTION

The present invention relates to methods for recycling salts and/or salt products from wastes and/or wastewaters to be used instead of salts and/or salt products from mining.

### BACKGROUND OF THE INVENTION

This local manufacture of acids will expand the ecological and/or economical recycling of salts and/or salt products because acids have been in wide use in recycling salts and/or salt products, but many of the acids that are useful in recycling contain salts that are in substantial use locally not nationally. These wastes can be separated according to analyses that can be recycled with one or more of the many acids but the number of locations that manufacture most acids are limited which limits economic recycling because of the high costs of shipment of acids and especially from distant sources. Wastes can be separated and purified for many uses and with use of U.S. Pat. No. 5,300,123, 1994 (Grott), for example. In other public understanding, salts and/or salt products can be recycled to provide feed for use of acids to manufacture other acids.

The present invention is the method of acid manufacturing using acid cation resins for recycling salt and/or salt products from wastes and/or waste water. The use of acid ion exchange exchanges hydrogen for the cations of the acid used in the separation. Local manufacture of acids by use of salty wastes and/or wastewaters contributes to reduction of these dangers and use of fossil fuel and that various acids can be manufactured locally in kind and volume that contribute to the local environmental and economical recycling of such wastes. The acid most commonly available is usually sulfuric acid so used in treating salts recycled from wastes and wastewaters to make other acids. A solution of 6% recycled sodium chloride is passed through a conventional acid cation resin ordinarily used for softening water by use of sodium chloride for regeneration of the resin. The cations of the selected recycled salt or salt product converts that recycled salt product into the acid of an anion for the recycled salt. This acid is a recycled acid product. There is a plurality of salt based acids and a plurality of organic acids that might be selected as the base for a recycled product.

### Demonstration

A 6% solution of purified recycled sodium chloride was passed through a bed of commercial resin in hydrogen form and exchange of hydrogen for sodium produced a solution of about three percent (3%) hydrochloric acid. The resin was loaded with the removed sodium and when regenerated with sulfuric acid produced recycled sodium sulfate for use in storage of heat, including renewable heat, U.S. Pat. No. 8,192,633 (Grott, 2012). “Use of low grade natural or recycled sodium sulfate in energy storage.”

### For General Use of “Recycled Sodium Sulfate”

After use, resin is regenerated using sulfuric acid to revert the resin to the hydrogen form and the in-water softening, but that cation resin in the hydrogen form and the exchange of hydrogen for sodium produced a relatively pure solution of about 3% hydrochloric acid. This process can be duplicated using salts recycled from wastes per U.S. Pat. No. 5,300,123 (Grott), 1994. For a plurality of recycled salts based on recycling various calcium, magnesium, potassium and sodium salts, the recycled salts are separated from wastes and/or wastewaters and with various anions that in turn combine with hydrogen to form corresponding variety of acids and new salt products with corresponding anions. An example is U.S. Patent Regeneration of the Cation Resin Produced Recycled Sodium Sulfate for use in many applications including all the Grott patents for uses of recycled salts. This same treatment of can produce a wide range of acids. Specifically, the present invention relates to use of the most available local acid to manufacture other acids which can be used to recycle salts with the sale anion of the acid that is used to make the separation. Typically, sulfuric acid is most available because United States (U.S.) production is about 37 million tons per year, which is 5 times as high as the production of nitric acid and 14 times as high as hydrochloric acid; however, hydrogen ions from any acid that can be used for regeneration of an acid cation resin by exchange of that hydrogen ion with the cations from the recycled salt makes an acid with the anions removed from the purified recycled salt or mix of salts. The present invention utilizes a salt or mix of salts recycled from wastes and/or wastewaters to produce a recycled acid. This allows production of a wide range of recycled acids made possible by the execution of the present invention. The ion exchange processes commonly grouped under the name of chromatography. The present invention utilizes the fact that use of even sulfuric acid to make a recycled acid by use of a recycled salt purified to be free of calcium ion and/or any other cation that is precipitated by the sulfate from the acid regenerates the acid cation resin, either weak or strong, to the hydrogen form while producing a new recycled sulfate salt(s) product with the cations from the recycled brine selected for this ion exchange. A series of cations can be recycled as sulfates, because the cations in the original recycled salt or mix of salts are removed separately in a known sequence.

### Chromatography

Developments in separation science relevant to biology and biomedical research include both fundamental advances and applications. Analytical techniques which may be considered include the various facets of chromatography, electrophoresis and related.

### SUMMARY

The acids most used in industry and science labs are sulfuric acid, nitric acid, hydrochloric acid, citric acid, and acetic acid

### Hydrochloric Acid—HCl

### Sulfuric Acid—H2SO4

### Nitric Acid—HNO3

### Nitrous Acid—HNO2

### Hypochlorous Acid—HClO

### Chlorous Acid—HClO2

### Chloric Acid—HClO3

### Perchloric Acid—HClO4

### Sulfuric Acid—H2SO4

### Sulfurous Acid—H2SO3

### Phosphoric Acid—H3PO4

### Phosphorous Acid—H3PO3

### Carbonic Acid—H2CO3

### Acetic Acid—HC2H3O2

### Oxalic Acid—H2C2O4

### Boric Acid—H3BO3

### Silicic Acid—H2SiO3

The volume of acid used in mixing the regeneration brine is always more than stoichiometric with the cations to be exchanged for the cations in the recycled salt(s). The pH of the used regeneration brine can be adjusted with the fertilizer ammonium hydroxide, which forms a dilute ammonium fertilizer for use or sale because of the wide local availability and a value that typically pays for more than both the acid and ammonium hydroxide used. Any of the following list of bases can be used for neutralization of acid within the recycled salt product(s) to optimize the fit with various uses thereof.

### Published List of Bases Used:

### Sodium Hydroxide—NaOH

### Potassium Hydroxide—KOH

### Ammonium Hydroxide—NH4OH

### Calcium Hydroxide—Ca(OH)2

### Magnesium Hydroxide—Mg(OH)2

### Barium Hydroxide—Ba(OH)2

### Aluminum Hydroxide—Al(OH)3

### Ferrous Hydroxide or Iron (II) Hydroxide—Fe(OH)2

### Ferric Hydroxide or Iron (III) Hydroxide—Fe(OH)3

### Zinc Hydroxide—Zn(OH)2

### Lithium Hydroxide—LiOH

The huge number of pairs of a selected local acid and a selected recycled salt provides selection from a multitude of recycled acids and a plurality of recycled salts and or recycled salt products according to the use of different acids.

For example, the commonly available acid is sulfuric acid and the recycled salt product is a relatively pure solution of salty wastes with the anion or anions as selected to pair with the hydrogen from the selected sulfuric acid.

As an example, for sulfuric acid, (U.S. production about 37 million tons per year) sulfuric acid is used to exchange hydrogen for the sodium in purified and recycled sodium chloride.

H₂SO₄+2NaCl->2HCl+Na₂SO₄

This example uses that common practice with high purity sodium chloride recycled from wastes and/or wastewaters as in production of sodium sulfate for use in U.S. patent and when the salt is any other recycled chloride free from calcium and/or other cations that are precipitated by a different acid locally available. HCl is still the acid produced, but the recycled salt product produced will still be the salt of the acid used for regeneration of that cation of the acid used.

### Ion Exchange Concepts for Heavy Metal Removal

www.wastechengineering.com/ion-exchange-concepts-for-heavy-metal-removal.html

“Basic Concepts” section reprinted from the EPA SUMMARY REPORT “Control and Treatment Technology for the Metal Finishing Industry—Ion Exchange,” EPA 625/08-81-007 . . . Table 1 gives the selectivity's of strong acid and strong base acid cation resins for various ionic compounds. Examples of Strong Acid Cation Exchanger and Strong Base Anion Exchanger, respectfully include:

### Strong Acid Cation Exchanger

### Barium

### Lead

### Calcium

### Nickel

### Cadmium

### Copper

### Zinc

### Magnesium

### Potassium

### Strong Base Anion Exchanger

### Ammonia

### Sodium

### Hydrogen

### Iodide

### Nitrate

### Bisulfite

### Chloride

### Cyanide

### Bicarbonate

### Hydroxide

### Fluoride

### Sulfate

### Table 1: Selectivity of Acid Cation Resins in Order of Decreasing Preference.

### Useful Links for Heavy Metal Removal

For example, nitric acid with U.S. production of about 7 million tons per year is used.

HNO₃+NaCl->HCl+NaNO₃ (useful as fertilizer for rice),

HNO₃+(recycled mix of calcium, potassium, magnesium nitrate, as recycled from agricultural use) produces a mix of nitrate fertilizers for reuse, as in recycling irrigation drainage where United Nations (U. N.) estimates that 12-15% of all land ever irrigated is now unproductive from accumulations of drainage. Regarding hydrochloric acid, U.S. production about 2.5 million tons per year is used with recycled salts of calcium, magnesium, potassium, singly or mixed, (for example recycled from irrigation drainage the recycled salts are recovered as individual salts).

Details about the use of various acids to regenerate acid cation resins are widely available. For Example, (http://msdssearch.dow.om/PublishedLiteratureDOWCOM/dh_0885/0901b80380885879.pdf?filepath=liquidseps/pdfs/noreg/177-01766.pdf) Found within this example are basic data on methods of conditioning water with DOWEX™ acid cation resins and explanations of how you can determine costs for removal of dissolved solids down to a part per billion. However, wastes very so widely in kind of cation and percentage and the local market for many of the common (Salts and/or Salt Products) that keeping an inventory of the numerous acids presents problems of safety and cost for both inventory and during shipments from often distant sources. The use of high purity recycled salts with a wide range of anions is used to make a safer and lower cost system when the more available acid is used to make other acids.

For example, when sulfuric acid is used with high purity recycled sodium chloride, hydrochloric acid is produced. The high purity recycled sodium chloride from waste brine in 1969 was produced using a license for our trade secret solar process which reduces purchased energy by 80% as compared with competitor production that uses steam made with natural gas and electric power with multi-effect steam heated evaporators. Investment was reduced by 60% and cost of electricity and natural gas was reduced by 80% as compared with all U.S. competitors. This licensed operation, including a paid-up perpetual license for use at that location was acquired by Morton Salt Company in 1985 by merger with tax free exchange of stock.

The use of conventional acid cation exchange to manufacture acids locally starts with use of Recycled Salt Products as Produced since 1985 by Morton Salt in a specialty solar salt operation under a non-exclusive trade secret license from Grott for a single location in Arizona.

U.S. Pat. No. 5,300,123 this new step whereby the use of cation exchange ion exchange for separation of individual salts and/or salt products cations of the dissolved waste salts can be recycled as various salts just by use of different acids for regeneration of acid cation resins, ion exchange to remove the dissolved cations individually by ion exchange of hydrogen for individual cations in a well-known sequence so that each cation can be removed individually. This process is known worldwide because of publicity generated by its use in separating metals used in the Manhattan Project and was eventually used for precise analysis of a solution containing one or more salts and was eventually named chromatography but this process is still just an acid ion exchange process. The present invention is about use of a safer and more flexible practice of using acids available locally from inventory of user or supplier for recycling cations as salts and/or salt products for various uses. A cation acid cation resin in the hydrogen form is used to treat a solution containing cations, from using a narrow inventory of acid to treat local available salts including salty waste and wastewaters. In general, this practice can be considered a variety of ion exchange chromatography whereby a locally available acid is used to manufacture another acid.

The present invention relates generally to the production of acids. More specifically, the present invention relates to the production of acids using ionic exchange media. The media can be a resin, a natural zeolite, or a manufactured zeolite. For convenience, the text describes the use of resins which are the highest volume of use of ion exchange media.

Ion exchange is a process between two electrolytes or between an electrolyte solution and a complex. Acid cation resins are insoluble polymers designed to exchange ions of solutions onto and from the surface of the resin to drive an ionic solution into the desired composition. The acid cation resin may be manufactured to be cation resins, attracting positively charged ions, or anion resins, attracting negatively charged ions. Acid cation resins are used in many processes for water softening, water purification, catalysis, pharmaceuticals as well as many other chemical reactions. The present invention provides a method of employing an acid cation resin(s) in hydrogen form to locally produce acids at sufficient concentrations to be used in various processes. Local production of acids reduces pollution from transportation methods and limits the possibility of hazardous spills during transportation. A cation resin exchanges the hydrogen ions for the salt cations within a salt solution. Thus, the solution becomes protonated to form an acid solution of the respective salt anion. Neutralization of the acidity by use of a basic anion exchange salt produces a salt or salt product with the cation of the basic salt used. Along with choice of acid cation, a wide latitude of salts is produced with best environmental and/or best economic use as compared with mined salts and/or salt products delivered by distant mining operations that usually produce unsaleable wastes and where shipping is costly in use of energy that is often a producer of greenhouse gases.

### BRIEF DESCRIPTION OF THE DRAWINGS

FIG. 1 is a flow diagram for the steps of the present invention.

### DETAIL DESCRIPTIONS OF THE INVENTION

The method of acid manufacturing with acid cation resins requires a plurality of different starting materials and equipment, which include a brine, an acid cation resin in hydrogen form, an acid solution, and an ion exchanger. More specifically, the brine, also known as a salt solution or brackish water, can be any ionic aqueous solution that comprises various cations, including but not limited to sodium, potassium, calcium, and magnesium, and various anions including but not limited to nitrates, chlorides, and sulfates. The acid cation resin in hydrogen form may be a strong or weak cation resin, which is initially charged or saturated with hydrogen ions, allows for the removal of cation from the solution. The sulfuric acid solution is used, as an example for the purpose of description, to regenerate the acid cation resin to allow a reuse of the acid cation resin, as well as increase its service life. The ion exchanger is a reactor which contains the ion exchange process without oxidation or reduction between the ions present in the solution. Moreover, the present invention has applications in deionization including production of ultrapure water, and for very frequent use in the energy production area like periodic use for reduction of salts in water for cooling towers which, along with the removal of collected solids by settling and/or filtration, etc. allows continuous use of the remaining water used in the cooling towers. and in production of natural gas and oil. Sulfuric acid produced from the sulfur from fuel, especially in sulfuric acid made from sulfur dioxide from oxidation of minerals and/or combustion of coal, is planned for use in construction of a government subsidized power plant dubbed as “clean burning coal.”

In addition, the present invention may also be applied in treating produced water the practice of production of oil and/or natural gas from wells, and is particularly useful in making and/or regeneration of fluids used for hydraulic ‘fracking’ where typically hydrochloric acid (HCl) is used to degrade the structure of shale formations, allowing access to previously untapped oil sources. Acidic solutions of salts which include recycled salts are pumped into the natural pores and induced fractures to open channels for the petroleum to flow through. Oils are then extracted according to industry standards including for flooding with various liquids that assist the release and flow of oil, gases, and water solutions through the production wells. The waste stream is then treated through the present invention and/or additional acid cation resin to recycle the waste stream into an effective and useable acid stream for the oil production process and/or, for recycling salts so the wastewater is conditioned for use in growing biomass for sustainability of fiber and fuel.

In one embodiment of the present invention, sulfuric acid is typically used for locally making hydrochloric acid and/or nitric acid, though most acids can be made using appropriate salts. There are technical benefits for this process. As mentioned before, a local production reduces pollution from fuel used during transport of dangerous material from distant sources. local production can utilize salts, and preferably waste salts and/or brines of sodium and/or potassium and/or other cations that do not precipitate in unacceptable amounts when contacted with the regeneration acid solution used for regeneration. In this manner, a wide variety of acids may be manufactured using whatever acid is locally available. This can provide an increased local use of sulfuric acid made from local acid gas and/or sulfur removed from fuels. The present invention reduces of dangers and costs for handling and transporting acid from more distant sources. Finally, handling acid cation resin in hydrogen form is inherently safe as compared with handling acids themselves.

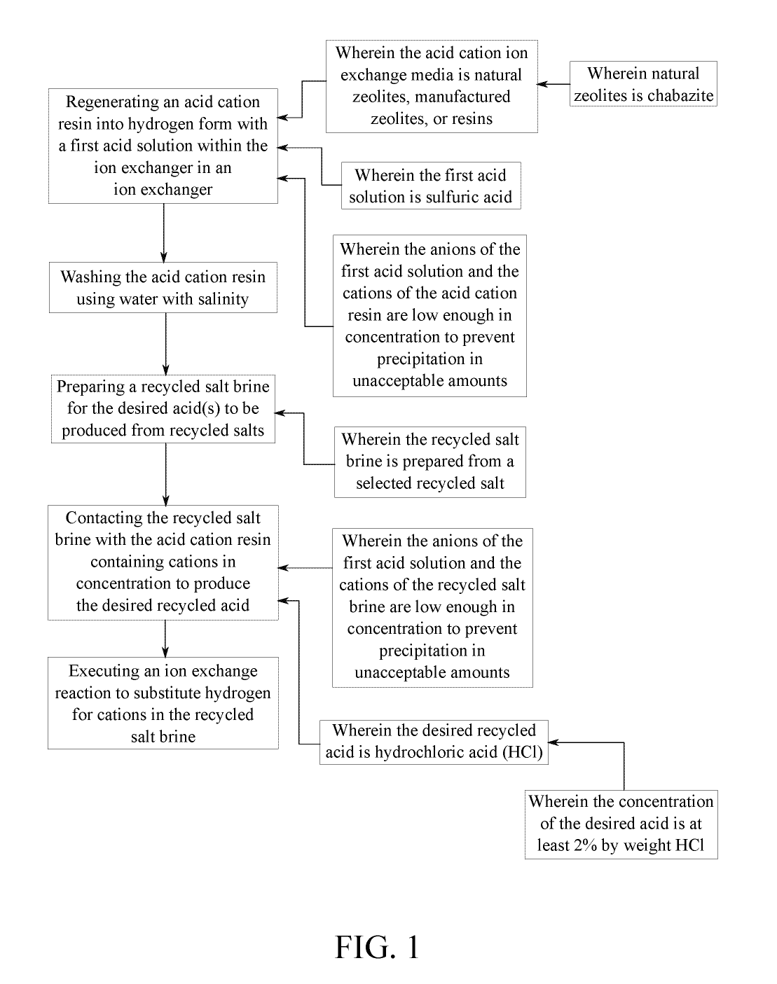

In accordance to FIG. 1, the present invention contains the steps as follows: regenerating an acid cation resin into hydrogen form with a first acid solution within the ion exchanger, strong or weak, depending on intended use of a desired recycled acid. The first acid solution is typically 1% to 3% or more acid content by weight, depending on molecular weight of the specific acid and intended use of the resin, and load an acid cation resin with hydrogen. The anions of the first acid solution and the cations of the acid cation resin are low enough in concentration to prevent precipitation in unacceptable amounts; washing the acid cation resin (now in a hydrogen form) using water with salinity, recommended by the resin manufacturer, to remove the regeneration brine; preparing a recycled salt brine for the desired acid(s) to be produced from recycled salts. Typically, but not necessarily, the recycled salts are waste salts and/or waste waters of the strength required are implemented for local use of acid to be manufactured as per directions from resin manufacturer, and/or working experience. The selected solutions are low enough in cations that form precipitates with the anions from the selected acid that precipitates, but not in an unacceptable amount; contacting the recycled salt brine with the acid cation resin containing cations in concentration to produce the desired recycled acid. The anions of the first acid solution and the cations of the recycled salt brine are low enough in concentration to prevent precipitation in unacceptable amounts; and subsequently executing an ion exchange reaction to substitute hydrogen for cations in the recycled salt brine typically with, but not necessarily, a waste water, until eventually, the recycled salt brine has been converted to a solution of HCl or nitric acid (HNO₃).

The acid cation ion exchange media may be chabazite or other natural zeolites, manufactured zeolites, or resins. In accordance to the process described above, all the steps may be performed in the same ion exchanger or locally, with no need of transportation. In addition, the process described above is not only able to remove sodium, the world's largest inorganic water pollutant from chloride brine to form hydrochloric acid, but also able to remove metals and other elements sequentially according preference of the acid cation resin except for calcium and/or other elements that form sulfates that precipitate under conditions of regeneration. Moreover, the same process may also be used to generate nitric acid. In this process, sulfuric acid is firstly used to regenerate an ion exchange, and then a nitrate brine is loaded to the ion exchange to generate a nitric acid. At the same time, the present invention can also remove metals and other elements sequentially according a preference of the resin because elements soluble in water do not form insoluble nitrates.

The process provided in the present invention allows local production of a plurality of acids using widely distributed sulfuric acid and reduces the known hazards of handling and transport of other acids from more distant sources. When an acid cation resin is regenerated to the hydrogen form and has been well washed to remove all traces of the four elements previously removed, that acid cation resin is in a standard condition essentially irrespective of the anion in the acid used for regeneration. The present invention has provided a safer and economical method for regenerating acid cation resin for a plurality of uses, including where a reduction in pH value is beneficial for limiting scale formation and/or removal of scale.

Moreover, the method according the present invention may be employed in an electric power generation. Utilities and other large operations using cooling towers commonly use lime-soda softening. Production of lime produces huge amounts of carbon dioxide and when used in water softening produces a huge amount of waste solids for disposal. Moreover, lime-soda softening leaves a troublesome amount of hardness in the “soft” water that eventually concentrates and forms precipitates, which will foul the cooling towers or similar apparatus. Use the acid ion exchange is able to reduce the hardness to a very low level and the buildup in salts is primarily sodium and potassium which are highly soluble, and the cooling water can thus be used to much higher concentrations. Further, the regeneration brines from removal of salts can be concentrated to hydrates for use in storage of heat and/or cooling.

Exchange of a hydrogen cation for any other cation creates an acid of the anion previously associated with that cation. The present invention may be implemented through various embodiment. The present invention uses an acid cation resin in the hydrogen form for contacting a solution of salt strong enough to make another acid for regeneration of acid cation resin. Typically, at least 2% for HCl, and preferably at least 3% for hydrochloride acid when used in regeneration of acid cation resin. In addition, the higher the acid content, the more uses in addition to regeneration of acid cation resin.

In one example of the present invention, about 3% of HCl is generated with acid cation resin and sodium chloride brine. A change from sodium chloride (NaCl) at molecular weight of 58.453 to molecular weight of about for HCl is a 41% reduction in produced weight from starting material to the obtained product. Sulfuric acid will produce certain CaSO4 precipitate and/or some other multivalent cations are precipitated as small solids that are mixed with the acid cation resin, and therefore sulfuric acid is not used with those salt solutions. Sulfuric acid is used to make acids primarily to remove such cations which are predominately in low amounts as compared with sodium, and because removing the cations separately, provides products with beneficial use or uses. In particular, the calcium chlorides or nitrates and magnesium chlorides or nitrates are particularly valuable for use with agricultural soils and for use in storage of solar energy and other sources of heat energy.

In the present invention, an acid cation resin in hydrogen form is used to remove the calcium; and then the regeneration is performed using an acid that does not precipitates form precipitates with any multivalent calcium or any other multivalent cation that may present in the water. Example of safety benefit is the regeneration of the acid cation resin to acid form in a safe centralized operation. Regenerated acid cation resin is used in portable ion exchange unit that may be transported to the point of use. For example, use in pH control of calcium and magnesium that form precipitates with carbon dioxide and/or sulfate ions which deposit to form scale and restrict flow in pumps and pipelines. Rather than injection of dangerous hydrochloride solution, a portion of the fluid is withdrawn, contacted with acid cation resin in hydrogen form, in amount to replace enough calcium and the like with hydrogen to reduce the pH value of the solution enough to avoid precipitates, as well as produce a usable brine.

The present invention has increased ecological benefits. Sulfuric acid that is made using sulfur dioxide, the world's largest volume acid gas, is used to recycle sodium, the world's largest volume of inorganic water pollutant, to make sodium sulfate, the world's most versatile material for storage of solar energy at child safe and pet safe temperatures in narrowed between narrowed intervals selected between 80 degrees Fahrenheit and about 89 degrees Fahrenheit. In addition, it has increased the safety for handling the hazardous acid. Adding acid to a solution is a common practice for pH control and is much used to minimize or prevent scale in heat transfer equipment, storage vessels, pumps and pipelines.

Although the invention has been explained in relation to its preferred embodiment, it is to be understood that many other possible modifications and variations can be made without departing from the spirit and scope of recycling as previously described in US patents.

### REFERENCES

1. Salt Production and Processing—Morton Salt www.mortonsalt.com/salt-production-and-processing/
   Note: Solar salt production is, typically, the capturing of salt water in shallow ponds where the sun evaporates most of the water. The concentrated brine precipitates . . . . This method yields a very high purity salt, fine in texture, and principally used in those applications requiring the highest quality salt.
2. U.S. Pat. No. 5,300,123, 1994—Method of reforming soluble salts to effect purification and increase crystal size thereof
3. U.S. Pat. No. 6,071,411, Method of treating soil for controlling dust and for effecting soil stabilization through the application of waste water, Jun. 6, 2000, Gerald J. Grott
   Note: Dust control and soil stabilization as in road beds, foundations, earthen dams, etc. Road bases in Northern Indiana and southern Michigan in 1960's have required minimal repair as compared with other road bases. Millions of tons of salts are required to optimize productivity of crop soils and increase permeability to gases and Water. Reduces Flood Water and retains it for use during summers.
4. U.S. Pat. No. 6,374,539, Methods of utilizing waste waters produced by water purification processing, Apr. 23, 2002, Gerald J. Grott
   Note: Use of sodium chloride and/or sodium sulfate to remediate excess calcium carbonate in soils. There are huge acreages of Carbonaceous soils in Arizona, California, New Mexico and on the east side of the continental divide. south of an East-West line through mid-Oklahoma, where summer soil temperatures can reach the 83 degrees Fahrenheit which is the temperature at which a Root eating Fungus will grow, but only if the carbon dioxide in the soil atmosphere reaches a minimum amount. High calcium and/or high sodium content result in soils with low permeability to gases as well as low permeability to water. Known as “Texas Root Rot,” by late 1800's the Texans funded an Agricultural Research Facility at College Station with specific goal of finding a remedy for Texas Root Rot. Eventually College Station became the base for Texas A&M Agricultural School but the cause for “Texas Root Rot” was discovered by Dr. Stuart D. Lyda while he was a Professor in Nevada. First, he found that only the roots of dicots were attacked. But that includes alfalfa, citrus, cotton and nuts which age large volume in Texas so College Station employed Dr. Lyda. Dr. Lyda found that adding one ton/acre of lowest grade of mined sodium chloride would cure Texas Root Rot. (about 95% sodium chloride or 1900 pounds per acre). Research and development in Montana found optimum treatment for all crops is about the same. We sold many truckloads of salt to Cotton Farmers who leased or purchased idle calcareous land, added a measured amount of salt and grew bumper crops. Cotton Incorporated gave massive support but environmentalists soon objected to adding chloride which would eventually reach the water table and Cotton Inc. quit advertising their support. But the sodium does the work, therefore, we patented use of both recycled sodium chloride and sodium sulfate. U.S. Pat. No. 6,651,383, Methods of utilizing waste waters produced by water purification processing, Nov. 25, 2003, Gerald J. Grott
5. U.S. Pat. No. 7,353,634, Methods of utilizing waste waters produced by water purification processing, Apr. 8, 2008, Gerald J. Grott
6. U.S. Pat. No. 7,622,044, Methods of sealing ponds and increasing water catchment with purified waste water, Nov. 24, 2009, Gerald J. Grott
7. U.S. Pat. No. 7,771,600, Methods of utilizing waste waters produced by water purification processing, Aug. 8, 2010, Gerald J. Grott
8. U.S. Pat. No. 7,717,173, Methods for Improving Oil and Gas Production with recycled, increased sodium water, May 18, 2010, Gerald J. Grott
   Note: Includes use of electrolysis because caustic soda and bleach were used in the successful department of energy (DOE) chemically enhanced oil recovery tests where we supplied the sodium chloride very low in calcium and magnesium used in improving oil recovery. Also covers some practices for recycling fracking water.
9. U.S. Pat. No. 7,823,641, Methods of formulating cements for drilled wells using processed waste water, Nov. 2, 2010, Gerald J. Grott
   Note: For sealing well casings.
10. U.S. Pat. No. 7,866,916, Recycled brines and salts for Ice Control.
11. U.S. Pat. No. 7,947,185, Water sanitation methods, May 24, 2011, Gerald J. Grott
   Note: A portion of the microbial contaminated water (as in drinking water, acid gas water, or sewage water) is electrolyzed to make bleach for use with the contaminated water
12. U.S. Pat. No. 8,062,532, Process for electrolytic production of chlorine products and byproducts, Nov. 22, 2011, Gerald J. Grott
   Note: Use Recycled sodium chloride as feed for electrolysis operations.
13. U.S. Pat. No. 8,091,653, Methods of formulating weighting agents using processed waste waters, Jan. 10, 2012, Gerald J. Grott
   Note: Use of Recycled Sodium chloride and calcium chloride as weighting agents in drilling fluid and fracking water.
14. U.S. Pat. No. 8,192,633, Methods of energy storage and transfer, Jun. 5, 2012, Gerald J. Grott
   Note: Use of low grade natural or recycled sodium sulfate in energy storage.

What is claimed is:

1. A method of acid manufacturing using acid cation resins for recycling salt and/or salt products from wastes and/or waste waters comprises the steps of:
regenerating an acid cation resin into hydrogen form with a first acid solution within the ion exchanger in an ion exchanger;
washing the acid cation resin using water with salinity;
preparing a recycled salt brine for the desired acid(s) to be produced from recycled salts;
contacting the recycled salt brine with the acid cation resin containing cations in concentration to produce the desired recycled acid; and
executing an ion exchange reaction to substitute hydrogen for cations in the recycled salt brine.

2. The method of acid manufacturing using acid cation resins for recycling salt and/or salt products from wastes and/or waste waters, as claimed in claim 1, wherein the anions of the first acid solution and the cations of the acid cation resin are low enough in concentration to prevent precipitation in unacceptable amounts.

3. The method of acid manufacturing using acid cation resins for recycling salt and/or salt products from wastes and/or waste waters, as claimed in claim 1, wherein the anions of the first acid solution and the cations of the recycled salt brine are low enough in concentration to prevent precipitation in unacceptable amounts.

4. The method of acid manufacturing using acid cation resins for recycling salt and/or salt products from wastes and/or waste waters, as claimed in claim 1, wherein the acid cation ion exchange media is natural zeolites, manufactured zeolites, or resins.

5. The method of acid manufacturing using acid cation resins for recycling salt and/or salt products from wastes and/or waste waters, as claimed in claim 4, wherein natural zeolites is chabazite.

6. The method of acid manufacturing using acid cation resins for recycling salt and/or salt products from wastes and/or waste waters, as claimed in claim 1, wherein the acid solution is sulfuric acid.

7. The method of acid manufacturing using acid cation resins for recycling salt and/or salt products from wastes and/or waste waters, as claimed in claim 1, wherein the desired recycled acid is hydrochloric acid (HCl).

8. The method of acid manufacturing using acid cation resins for recycling salt and/or salt products from wastes and/or waste waters, as claimed in claim 1, wherein the concentration of the desired acid is at least 2% by weight HCl.

9. The method of acid manufacturing using acid cation resins for recycling salt and/or salt products from wastes and/or waste waters, as claimed in claim 1, wherein the recycled salt brine is prepared from a selected recycled salt.
